(19) United States
(12) Patent Application Publication
(10) Pub. No.: US 2010/0108753 A1
(43) Pub. Date: May 6, 2010

(54) Method for sequential identification of samples

(76) Inventors: Nicolas Bara, Paris (FR); Anne Jann, Paris (FR); Dominique Vitoux, Paris (FR); George Bagnard, Paris (FR)

Correspondence Address: HARNESS, DICKEY & PIERCE, P.L.C., P.O. BOX 828, BLOOMFIELD HILLS, MI, 48303, US

(21) Appl. No.: 11/988,963

(22) PCT Filed: Jul. 13, 2006
(86) PCT No.: PCT/FR2006/001722

§ 371 Date: May 15, 2009

(30) Foreign Application Priority Data
Jul. 20, 2005 (FR) 0552252

(51) Int. Cl. G06K 9/00; G06F 17/00

(52) U.S. Cl. 235/375; 235/435

(57) ABSTRACT

The invention concerns a method for identifying a plurality of samples (1), characterized in that it includes: a step of preparing an assembled storage of a plurality of samples (1), in a block (3) comprising a first identification marking M1 and a plurality of detachable supports (2), each containing at least one of said samples; a step of separating one support, consisting in separating the support (2) corresponding to said block, and in irreversibly associating said support with a second identification marking M2. Said method enables samples to be securely identified and to be easily traced.

### CROSS-REFERENCE TO RELATED APPLICATIONS

This application is a National Phase Entry of International Application No. PCT/FR2006/001722, filed Jul. 13, 2006, claiming priority to FR 0552252, filed Jul. 20, 2005, both of which are incorporated by reference herein.

### BACKGROUND AND SUMMARY

The invention relates to a method for identifying a plurality of samples.

Laboratories of all types have an increasing need for sample storages with a view to their subsequent analysis or with a view to making sample collections. The more or less long term storage often implies deep-freezing the sample. The variety of subsequent uses of the samples makes it necessary to multiply the number of samples made from the same sampling. Such multiple samples are often of a small size.

Such storage imparts several difficulties, more particularly as regards the identification and the traceability. As a matter of fact, it is absolutely necessary to know the origin of a sample, since a great number of samples can be obtained from the same sampling and the samples from various samplings are then stored together. In a similar way, it is necessary to know the “life” of a sample, which means knowing with great precision the moment it was stored, knowing whether it was taken out of the storage enclosure and whether it has been placed back after making an analysis or not. In the case of deep-frozen samples, it is also necessary to know whether the cold chain has been interrupted and whether the sample could have been deteriorated when being handled or not.

Various samples identification and follow-up methods have been provided. According to one embodiment, all the samples supports are pre-identified before receiving a sample and the samples are stored individually. Such an embodiment has numerous disadvantages. As a matter of fact, the individual storage of each sample makes their handling difficult more particularly by a machine, considering their small size. Besides, an efficient identification, using electronic chips for example, has a very high cost and, as each support is pre-identified, such cost very rapidly increases for a big collection of samples. Generally speaking, only a few samples will be used for analysis, the other being destroyed if they are not used. Many samples will thus be identified without really needing to be and the costs incurred for such identification are lost. Eventually, as regards the samples intended to be stored a very long time, the identification is made as soon as the sample is stored, without knowing whether the identification systems used will still be prevailing when the sample is actually used or whether more efficient identification systems will be existing or not.

To remedy a part of such disadvantages, it has been provided, more particularly in document FR-2 780 903, to make an assembled storage of the samples from the same source. For this purpose, a “one-piece” plate is provided, fitted with detachable cups, each bearing a sample. The storage is thus facilitated since the samples from the same source are transported and stored together, which makes handling easier and more particularly for a machine. In addition, the identification of the samples from the same source is simplified, only one identification mean being necessary for one plate. Finally, the traceability of samples is enhanced since, when a cup is detached from the plate, a mark is left on the cup and on the plate. Thus, it is possible to known whether a sample was handled or not. However, each sample must also be identified individually. For this purpose, it is provided to pre-identify each cup. Then, the same disadvantages as those mentioned above are to be met again once the cup is detached from the plate. An application of such principle with unitary cups of a small size is technically and economically a problem, since the separate pre-identification of each sample becomes difficult to make (because of a lack of room) and proportionally very expensive.

The invention aims at remedying such disadvantages by providing a method for identifying a plurality of samples in which the individual identification of each sample is made only when the sample is actually used. This will be called a sequential identification of samples. For this purpose, the invention relates to a method for identifying a plurality of samples including:
a step of preparing an assembled storage of a plurality of samples, in a block comprising a first identification marking M1 and a plurality of detachable supports containing each at least one of said samples;
a step for utilizing a support consisting in separating the corresponding support from said block and in irreversibly associating said support with an identification marking M2.

Such an embodiment offers many advantages. As a matter of fact, the samples are first stored and identified when assembled on a one-piece device, which makes it easier to store and identify the samples. A sample is thus only identified by its relative position on the block, which is a particularly simple and economical identification system, an advantage which is amplified in the case of small size and numerous samples. Besides, one-piece devices are much more easily robotized than sample unitary containers. The individual identification of each sample is then made when the support is detached from the block which it belongs to.

Thus, only the actually used samples are individually identified, which makes it possible to save substantial money for such identification, with the unused samples not having to be identified outside of the block identification system. Besides, in the case of long-term storages, the identification system for one sample can be chosen among the most efficient identification systems available upon the utilization of the samples. The method according to the invention thus makes it possible to adapt to the technological progress and the separate identification system cannot become obsolete.

As regards the storage and the use of the sample, the embodiment makes it possible to solve in the optimum way all the problems related to the antagonism of such two phases: the storage is dense and its economical characteristics allows for a viable and secure management of a large number of small sized samples. In the utilization phase, in addition to the secured separate traceability, the method offers the advantage of providing the user with the selection of the physical support for the individual identification of the sample. Such selection can then be made in full knowledge of all the considerations involved and adapted to the nature of the use of the samples, which is indicated as unknown at the time of the storage. Eventually, the individual identifiers of the samples do not have to undergo the constraints of a long-term storage in a generally hostile environment.

According to one embodiment, the utilization step is carried out in the form of an operation prohibiting access to the isolated support by an operator. The utilization step is carried out in an automated equipment included in a closed enclosure and comprises the separation of the support from the original block and the irreversible association of said support with the marking M2 as well as the recording of the pair (M1, M2). Thus, any manual handling is avoided during the manipulation of the samples separated from the block. This avoids any identification mistake and ensures a good traceability of the samples.

According to one embodiment, during the utilization step, the support receives a marking M2 which takes account of the marking M1 of the block, which the considered support is detached from, as well as the coordinates of said support in said block. The connection between the sample and the sampling it originates from is thus clearly identified, which enhances the traceability of the sample. Other aspects and advantages of the invention will appear evident while reading the following description and referring to the appended drawings.

### BRIEF DESCRIPTION OF THE DRAWINGS

FIG. 1 is a perspective diagrammatic representation of a block according to the invention, a support being detached from said block and bearing an individual marking according to one embodiment of the invention.

FIG. 2 is a cross-sectional diagrammatic representation of the support of FIG. 1, said support bearing an individual marking.

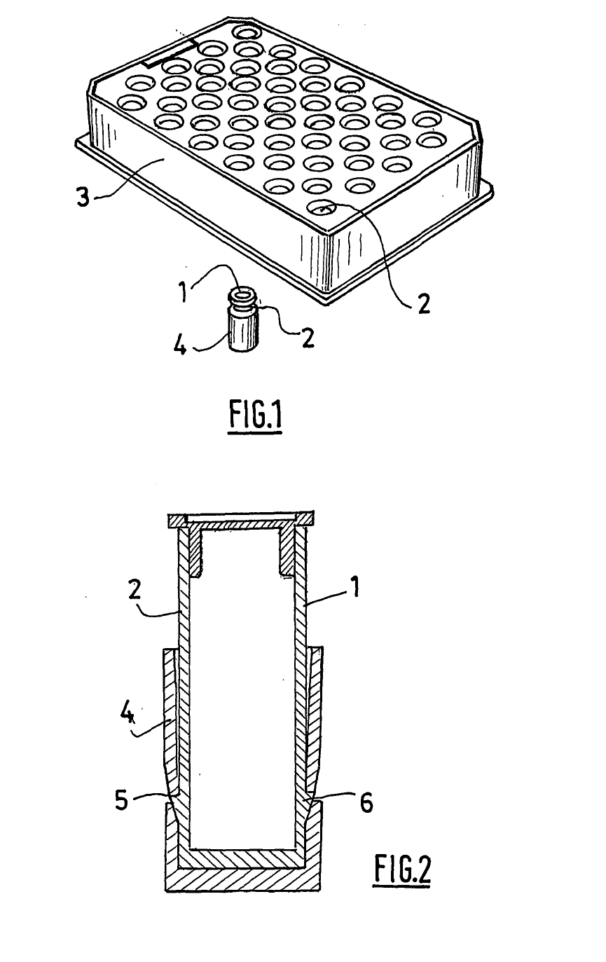

### DETAILED DESCRIPTION

While referring to the Figures, a method for storing and using a plurality of samples 1 is described. When a sampling is made, the sampled product is divided into several samples which are, each, placed on a support 2. Such conventional step is also called making aliquot portions. The support 2 can have any shape adapted to the sample which it is intended for. For example, this can be a cup, as shown in the Figures, glass plates on which a drop or a slice of the sampled product is spread or any other appropriate shape.

The support 2 is detachably associated to a block 3, thus forming a “one-piece” device comprising a plurality of other supports 2 of the same type. The filling of several supports 2 by samples can thus be easily carried out in an automated and quick way, the block 3 having for example dimensions which make it easy to grip for a robot. The block 3 can for example be of the same type as the one described in document FR-2 780 903. This means that according to the embodiment shown in the Figures, the block 3 has the shape of a plate with several detachable cups forming a support 2 and receiving, each, a sample 1. Any other shape of the block 3 which is adapted to enclose separable supports can thus be considered. Thus, the block 3 could have the shape of a very large plate with cut out lines thus defining platelets forming detachable supports, along the cut out part, along said lines.

In one embodiment, the supports 2 are made integral with the block 3 as from the manufacture thereof. In another embodiment, the supports 2 are made integral with the block 3 during the step of preparing the storage of samples. Making the supports 2 integral with the block 3 can be done upon the step of making the aliquot portions. Thus, the supports 2 are filled unitarily then locked on the block 3. The locking system includes a control making it possible to leave an irreversible trace on the block 3 and/or the support 2 if the support 2 is removed from the block. This embodiment is more particularly appropriate in the case of a filling circuit for samples 1 which are not adapted to such one-piece devices but to unitary supports 2.

The block 3 includes a first identification marking M1 making it possible to identify the latter in a storage enclosure. The marking M1 can be made in any possible way, for example by simply sticking a label bearing identification information or by writing a number. According to one embodiment, the marking M1 is composed of a bar code engraved into material of the plate. According to another embodiment, the marking M1 is composed of means likely to be read from a remote place, engraved into material of the plate such as an electronic card able to communicate with a terminal storing the storage information. When the support 2 is associated with the block 3, the support 2 is identified by its position on said block 3. No additional identification marking is required since the support 2 is not isolated from the block which it belongs to, and it cannot be isolated without leaving an indelible trace on itself and said block, either.

When the filling of supports 2 is completed, the latter are closed in order to preserve the integrity of the samples they contain. The closing of the support can be made such that any subsequent opening leaves an irreversible mark, visible with the naked eye, which makes it possible to see that the sample is likely to be altered or modified after the filling of the support 2. The block 3 is then placed in a storage enclosure. The storage enclosure can be provided with means making it possible to check the input and output of said enclosure. It can be cooled if so required for the preservation of samples.

When a sample 1 must be used, the support 2 bearing said sample is detached from its block 3. The block 3 and the support 2 can be so arranged that the detachment of the support 2 from the block 3 leaves an irreversible mark which can be noticeable with the naked eye and makes it possible to see whether a support 2 has been detached from the block 3. Such an embodiment is for example described in document FR-2 780 903. During such step, after the block 3 is detached, the support 2 is irreversibly associated with the second identification marking M2 making it possible to individually identify the support 2 when it is detached.

During such utilization step, no operator can have access to the isolated support 2. The utilization is for example carried out in the closed enclosure of an automated equipment and includes the detachment of the support 2 from the original block 3 and irreversible association of said support with the second marking M2. The enclosed enclosure can be cooled in order to avoid any cold chain interruption, if necessary.

According to the embodiment shown in the Figures, the support 2 is composed of a cup, which a sleeve 4 enclosing said cup when the latter is detached from the plate is irreversibly associated with. The sleeve 4 thus bears the identification marking M2. FIG. 2 shows the irreversible association of the sleeve 4 with the cup. As can be seen, the sleeve includes a slot 5 so arranged as to receive a protrusion 6 of the cup. The slot 5 and the protrusion 6 are so arranged that the removal of the cup from its sleeve 4 is impossible without breaking the assembly. Thus, the cup and/or the sleeve 4 include at least one mean such that, after the association of the sleeve 4 with the cup, any access to the sample necessarily entails an irreversible physical transformation, which can be noticed by the naked eye, of said cup and/or of said sleeve. Such means can also be constituted by a breakable leg in case of withdrawal of the cup from its sleeve 4, or any other device aiming at making the association of the support 2 and the marking M2 tamper proof.

It should be noted that in the embodiment shown, the marking M2 is a unitary marking which identifies only one sample. The marking M2 can have any shape adapted to the support 2. Then, it is possible to provide associating to the support 2 an element bearing the marking M2, as mentioned hereabove or if the support is adequately designed, to provide the marking M2 exactly on the support. The marking M2 can for instance be in the form of some engraving or have any format suitable for an identifying system.

According to an embodiment, the second marking M2 is calculated as a function of the first marking M1 of the block 3 which the considered support 2 is detached from, as well as the coordinates of said support in said block. Thus, the marking M1 and the marking M2 are correlated. However, it can be necessary to obtain a marking M2 unrelated with the marking M1 if a step of recording the pair (M1, M2) is planned. The marking M2 can be constituted of time stamped digital data, encapsulated by an electronic signature.

According to one embodiment, the marking M2 like the marking M1 can be constituted by means associated to the sleeve and likely to be read from a remote place. Such means can have the shape of an electronic chip capable of communicating with a terminal storing the storage information.

According to one embodiment, the marking M1 is borne by an electronic chip associated with the block 3 and the marking M2 is borne by an electronic chip associated with the support 2, when the latter is detached from the block 3. The method then comprises a step of data communication between the chip bearing the marking M1 and the chip bearing the marking M2. The chip bearing the marking M2 contains all the marking M1 information and the sample 1 and the sampling it comes from can be efficiently identified. As mentioned above, the marking M2 being made or associated when the sample 1 is removed from the storage, such marking can be adapted to all the technological evolutions in the identification systems as well as any use of the sample.

In one embodiment, the method is a method for the sequential identification of samples and includes several utilization steps. As a matter of fact, the support 2 may include a plurality of secondary supports. During the first utilization step, a support 2 can be separated from a block 3, and such support 2 can be associated with a second marking M2 and the pair (M1, M2) is recorded. Eventually, during a third utilization step, the secondary support is separated from the support 2, marked M2, and but a secondary support is irreversible associated with a third identification marking M3 and the couple (M2, M3) is recorded. It should be noted that the number of utilization steps is not limited and that the secondary supports may include a plurality of tertiary supports.

In another embodiment not shown, the marking M2 or M3 is made on a second block. Thus, during the utilization step, an assembled storage of sample is further prepared. The support 2 or secondary support is detached from the original block 3 then associated with a second block containing a plurality of samples and including the second or third identification marking. The marking of the second block is then adapted as a function of the marking of the original block 3, coordinates of the support 2 or secondary support in the original block 3 and coordinates of the support 2 or secondary support in the second block. The marking M2 or M3 is thus an indexation marking giving informing more particularly on the position of support 2 or secondary support in the second block.

In the previously described embodiment, the method further comprises an additional utilization step consisting in separating the support 2 or secondary support from the second block, and irreversibly associating with said support 2 or secondary support an additional identification marking. It should be noted that during the additional utilization step, the support 2 or secondary support can be associated with a third block and that there can be a plurality of additional utilization steps. Thus, the identification method is a multi-sequential method. The previously described identification method is particularly adapted to the identification of biological or chemical samples, but can also be adapted to any other type of samples.

Eventually the invention is described as an example and it should be understood that the specialist can make various alternative of the invention without going out of the scope of the invention.

1. A method for identifying a plurality of samples, the method comprising:
preparing an assembled storage of said plurality of samples, in a block comprising a first identification marking and a plurality of detachable supports, each containing at least one of said samples; and
using a support, including separating said support corresponding to said block, and irreversibly associating said support with a second identification marking.

2. An identification method according to claim 1, wherein said support comprises a plurality of secondary supports, said method further comprising:
using a secondary support, including separating said secondary support from said support, and irreversibly associating said secondary support with a third identification marking.

3. An identification method according to claim 1, wherein said second marking includes at least one of: (a) a unitary marking, and (b) an indexing.

4. An identification method according to claim 1, wherein the utilization step is carried out in the form of an operation prohibiting access to said isolated support by an operator.

5. An identification method according to claim 4, wherein the separation step is carried out in a closed enclosure of an automated equipment and includes the detachment from said support of said original block, and the irreversible association of said support with said second marking, as well as the recording of the pair of markings.

6. An identification method according to claim 5, wherein said enclosure is refrigerated.

7. An identification method according to claim 1, wherein said supports are made integral with said block during the preparation step.

8. An identification method according to claim 1, wherein said supports are made integral with said block during the manufacturing of said support.

9. An identification method according to claim 1, wherein said support receives, during the utilization step, said second marking computed as a function of said first marking of said block, said support of which is detached, as well as coordinates of said support in said block.

10. An identification method according to claim 1, wherein said second marking includes data stamped numerical data, encapsulated by an electronic signature.

11. An identification method according to claim 1, wherein said assembled storage is carried out using a plate having a plurality of detachable cups forming said support and receiving, each, the sample, said plate having said first identification marking.

12. An identification method according to claim 11, wherein said first marking includes a bar code engraved in the material of the plate.

13. An identification method according to claim 1, said first marking includes means likely to be read from a remote place, and engraved in the material of the plate.

14. An identification method according to claim 11, wherein at least one of said cups is irreversibly associated with a sleeve surrounding said cup when the latter is detached from said plate, said sleeve bearing the second identification marking.

15. An identification method according to claim 14, wherein said cup and said sleeve includes at least means such that, after a sleeve is associated with the cup, any access to the sample necessarily entails an irreversible physical transformation, noticeable with the naked eye, of said at least one cup and/or said sleeve.

16. An identification method according to claim 15, wherein said means is a breakable leg.

17. An identification method according to claim 14, wherein said second marking includes means likely to be read from a remote place and associated with said sleeve.

18. An identification method according to claim 1, wherein said first marking is borne by an electronic chip associated with said block and said second marking is borne by an electronic chip associated with said support when the latter is detached from said block, the method further comprising a step of communication of the data between the chip bearing the first marking and the chip bearing the second marking.

19. An identification method according to claim 2, wherein during the utilization step, an assembled storage of said samples is further prepared, at least one of said supports being associated with said second block containing a plurality of said samples and including said second or third identification markings; said method further comprising an additional step of utilization consisting in separating said support or secondary support from said second block, and in irreversibly associating said support or secondary support with an additional identification marking.
